(19) United States
(12) Patent Application Publication
(10) Pub. No.: US 2002/0148628 A1
(43) Pub. Date: Oct. 17, 2002

(54) Integrated telecommunications cabinet system with DSX assemblies and multiplexers

(76) Inventors: Jim Vercruyssen, Spokane, WA (US); Peter Mohr, Hayden, ID (US); Jon Thorpe, Liberty Lake, WA (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 09/837,622

(22) Filed: Apr. 17, 2001

(51) Int. Cl. H02G 3/08

(52) U.S. Cl. 174/50

(57) ABSTRACT

A telecommunications cabinet system in which a cabinet with a first end and a second end includes a plurality of DSX-1 and/or DSX-3 jack assemblies and at least one multiplexer, are mounted such that they may be accessed from an end of the cabinet framework. The preferred system includes fifty-six DSX-1 jack assemblies and two active M13's, with two standby or redundant M13's being available for use.

### TECHNICAL FIELD

This invention relates to a cabinet system for use in telecommunications which includes both digital cross-connect connections and multiplexer connections in a single cabinet.

### BACKGROUND OF THE INVENTION

With the large increase in demand for telecommunications capacity, there is an increasing need for greater density and capacity in all areas of telecommunications, including signal transmission, connections or cross-connections, and terminations. The better utilization of a given amount of space in telecommunications facilities is becoming more and more important.

In many facilities there are bays or racks in which different types of cabinets and other equipment are mounted. In the prior art example illustrated in FIG. 1 for instance, there is a typical rack configuration which requires digital signal cross-connects (“DSX”) jack assemblies and also requires multiplexers, sometimes designated as M13's (sometimes also referred to as “MUX”).

Multiplexers are devices which facilitate the transmission of two or more signals over a single line, such as by time-division multiplexing or wavelength-division multiplexing. In multiplexing, the term or designation “M13” indicates a multiplexer/demultiplexer for DS1 to DS3 signals. A DSX-1 is a digital signal cross-connect for electrical T1 or DS1 (digital signal 1 transmission rate, 1.544 Mb/s) transmission signals. A DSX-3 is a digital signal cross-connect for electrical T3 or DS3 (digital signal 3 transmission rate, 44.736 Mb/s) transmission signals. E1 is a European signal transmission rate of 2.048 Mb/sec, and there are generally twenty-one E1's in a T3. It should be noted that this invention is not limited to any one transmission standard or rate.

DSX assemblies are typically used for the electrical connection between cables in a central office, for cross-connecting and for the termination of lines at various locations.

FIG. 1 illustrates a perspective view of a prior art configuration which includes a separate multiplexer cabinet 100 mounted near a separate DSX-1 cabinet 101. The multiplexer cabinet 100 includes at least one multiplexer 102 mounted therein and the DSX-1 cabinet 101 configuration includes a plurality of DSX-1 bantam jack assemblies 103 therein. In a typical prior art application, a multiplexer cabinet 100 would be mounted near a separate DSX-1 cabinet 101 to provide the multiplexing capability for the DSX-1 circuits. The multiplexer cabinet 100 and the DSX-1 cabinet 101 would typically be provided with the adapter hardware to be mounted to the desired location, such as an industry standard rack. There may also be a separate DSX-3 cabinet above the two shown in FIG. 1, requiring even further additional space.

Since the respective cabinets shown in FIG. 1 are dedicated to either DSX-1 circuits or jack assemblies 103 or M13 circuits 102, they must be mounted near one another and are typically hard wired to one another. One of ordinary skill in the art will appreciate the desire to increase circuit density and minimize vertical rack space in facilities and in applications which require both DSX-1 circuits and M13 or other multiplexer components.

It is also desired to reduce the amount of time required to wire together DSX jack assemblies to multiplexers and providing an integrated system accomplishes this.

### BRIEF DESCRIPTION OF THE DRAWINGS

Preferred embodiments of the invention are described below with reference to the following accompanying drawings.

FIG. 1 is a perspective view of a prior art configuration which includes a separate multiplexer cabinet and a separate DSX-1 cabinet;

FIG. 2 is a perspective view of an embodiment of this invention which includes fifty-six DSX-1 jack assemblies and four (preferably two active and two standby) multiplexers, the four multiplexers being in the middle of the first end of the cabinet framework;

FIG. 3 is a perspective view of an embodiment of this invention which includes fifty-six DSX-1 jack assemblies and four multiplexers, with two multiplexers being on each outward side of the first end of the cabinet framework;

FIG. 4 is a perspective view of an embodiment of this invention which includes DSX-1 jack assemblies, DSX-3 assemblies and four multiplexers, with two multiplexers being on each outward side of the first end of the cabinet framework;

FIG. 5 is a perspective view of an embodiment of this invention which includes DSX-1 jack assemblies and four multiplexers, the multiplexers being configured within the cabinet but above the DSX-1 assemblies;

FIG. 6 is a functional block diagram of the cabinet system components of one embodiment of a cabinet system contemplated by this invention;

FIG. 7 is a system block diagram of the cabinet system components of one embodiment of a cabinet system contemplated by this invention;

FIG. 8 is a diagram of the relationship of FIGS. 9-11, which is an electrical block diagrams of one embodiment of a cabinet system contemplated by the invention;

FIG. 9 is an electrical block diagram of the cabinet system components of one embodiment of a cabinet system contemplated by this invention, as depicted in FIG. 8;

FIG. 10 is an electrical block diagram of the cabinet system components of one embodiment of a cabinet system contemplated by this invention, as depicted in FIG. 8;

FIG. 11 is an electrical block diagram of the cabinet system components of one embodiment of a cabinet system contemplated by this invention, as depicted in FIG. 8; and

FIG. 12 is a perspective view of an embodiment of this invention which includes DSX-3 assemblies and four multiplexers, with two multiplexers being on each outward side of the first end of the cabinet framework.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

The term “framework” as used herein need not be continuous or in any specific number of pieces. However it will be appreciated by those skilled in the art that the framework could be one piece, two piece or more than two pieces. Furthermore, the framework as contemplated by this invention need not be in one continuous section, but instead may also be divided up into multiple sections or segments.

The DSX portion of the cabinet system may be a cabinet with modules such as those disclosed in commonly owned U.S. Pat. Nos. 4,975,087 and 5,938,478, both of which are hereby incorporated herein by this reference as though fully set forth herein.

The term plurality of jack assemblies as used herein is intended to cover a plurality of jack circuits, and/or a plurality of columns of sleeves disposed to receive jack plugs, whether the front panel is one piece with the front panels of adjacent jack assemblies. Thus a one piece front panel with a plurality of jack circuits and/or a plurality of columns of sleeves, is a plurality of jack assemblies as used herein. The jack assemblies may also be single circuit replaceable, although the invention is not limited to any one type of DSX assembly or configuration in particular.

The term DS1 (or T1) generally refers to a digital signal 1 transmission at a rate of 1.544 Mb/s and the term DS3 generally refers to a digital signal 3 transmission at a rate of 44.736 Mb/s, both of which are well known in the industry. The term “mux” is well known in the art and generally refers to multiplexers. The term M13 or M13 or “1-3 mux” is also well known and generally refers to multiplexers for DS1 to DS3 signals. The term DSX generally refers to “Digital Signal Cross-Connects” and a DSX-1 is a digital signal cross-connect for DS1 signals. T1 is also referred to as Digital Signal Level One (DS1), which is a standard for high-speed digital transmission. T1 facilities generally operate at 1.544 Mbps, the equivalent of twenty-four—64 kbps channels (DS0 or Digital Signal Level 0 channels). T3 is twenty-eight T1's running at 44.736 Mb/second.

Some embodiments of this invention generally include a combination of DS1 digital cross-connects with DS1 or DS3 multiplexing (1-3 mux or M13). In one embodiment, fifty-six DSX module and one or two M13's can be installed in what is known as a single nineteen inch wide and five and one-quarter inch tall size unit, in a cabinet or framework configuration.

There are numerous alternative embodiments and configurations within the contemplation of this invention, for example but without limitation, embodiments which interface with high speed DS3 connections, or with fiber optical broadband connections. Additional features may be included in the invention, such as DS0 grooming. DS0 is Digital Signal level 0, 64 kbps or 64,000 bits per second. There are twenty four DS-0's in a DS1.

Preferred cabinet framework dimensions allow the cabinet framework to fit on industry standard rack lengths, an example of which is generally referred to as a nineteen inch rack. It should be noted however that the rack may be any one of a number of different desirable or standard sizes, such as what is generally referred to as a twenty-three inch rack as well, with the invention not being limited to any one in particular. For the standard nineteen inch rack, the cabinet framework dimensions may be seventeen and thirty-eight one-hundredths wide, five and two-tenths high and twelve inches in first end to second end depth. The increased density for the components provided by this embodiment of the invention would be one to four M13 and fifty-six DSX-1 jack assemblies in less than five and one-quarter inches of vertical rack space or height in what is referred to as a nineteen inch wide rack. The cabinet framework may be configured to be mounted in any one of a number of different ways, preferably to customer racks via rack mounting adapters which are generally known and used in the industry.

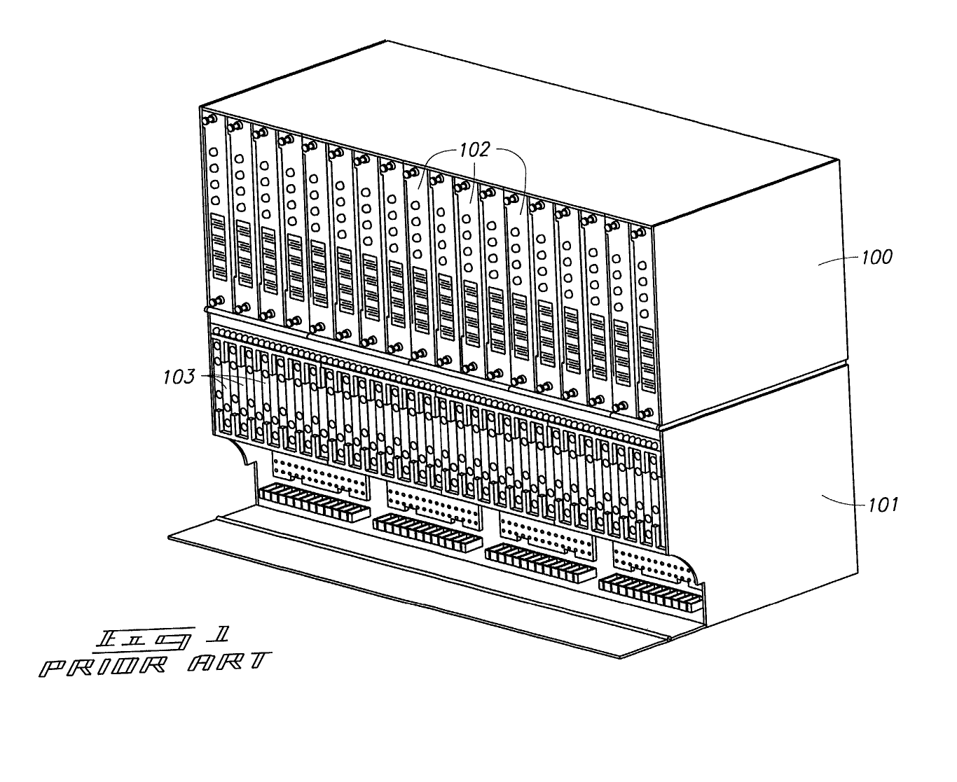

It will be appreciated by those skilled in the art that this component density, as compared to the prior art (FIG. 1), yields significantly higher density for a fifty-six circuit DSX-1 with M13 capability.

It will also be appreciated by those of ordinary skill in the art that the invention may be provided not only with one or two active M13's, but also with one or two standby M13's.

The DSX cabinet may be any one of a number of different cabinets with bantam jack modules, such as those disclosed in U.S. Pat. Nos. 4,975,087 or 5,938,478, to name a few.

In a typical application, one multiplexer may be used for approximately twenty-eight DSX-1 circuits and two multiplexers for fifty-six DSX-1 circuits.

The backplane termination configuration includes four sixty-four (64) pin “D” style or type connectors, two RJ45 connectors, four BNC connectors, two power/return connectors, one dual chassis ground stud, four drain wire ground studs and two dry alarm connectors. No particular backplane termination configuration is required to practice this invention as there are numerous configurations within the contemplation of this invention. Wire cable management provisions may also be provided.

Embodiments of the invention further include a dual M13 with a built-in fifty-six circuit DSX panel. The M13 will allow twenty-eight dedicated DS1 channels to be multiplexed into one DS3 channel. Examples of some alternative embodiments and/or alternative product configurations, within the contemplation of this invention may include: single M13 with a DSX panel (DSX-1 and/or DSX3); dual M13's with independent DSX panels; or a single M13 with a dual DSX panel, to name a few.

System embodiments within the contemplation of this invention allow the user flexibility to expand for increased bandwidth. For instance, a user with a configuration with only one M13 with a single DSX panel may later add an additional M13 by merely adding the additional components to the cabinet framework, allowing the user to increase the bandwidth of the system.

The term backplane interconnect conductor as used herein generally refers to the conductor or series of conductors which electrically connect the plurality of DSX-1 jack assemblies and the at least one multiplexer to the backplane printed circuit board assembly, and may be a printed circuit board, a connector ribbon, or any one of a number of other individual or combined components which may be used to electrically connect the components.

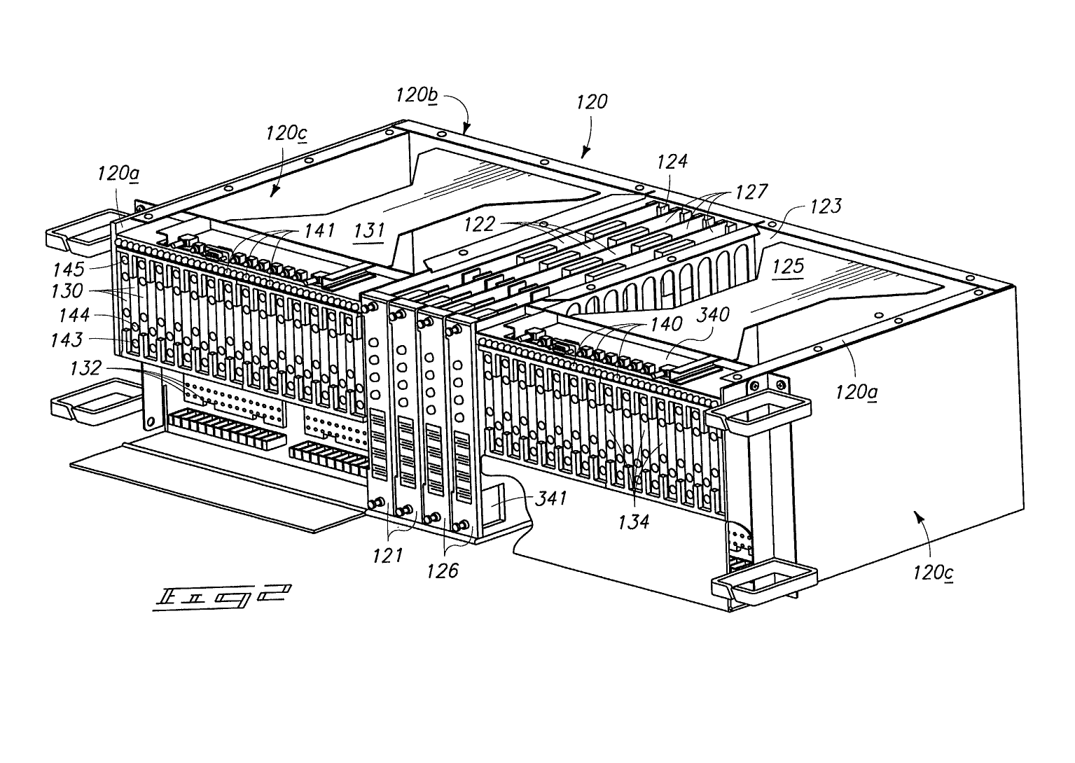

FIG. 2 is a perspective view of an embodiment of this cabinet system invention, illustrating cabinet framework 120, first end 120a, second end 120b, and side walls 120c. FIG. 2 illustrates two sets of DSX-1 jack assemblies 130 and 134, with the preferred number being twenty-eight jack assemblies per set (although no specific number of either jack assemblies or multiplexers, are required to practice this invention). It should be noted that the first end 120a will generally be the front end or the aisle end, whereas the second end will generally be the rear end opposite end.

The DSX-1 jack assemblies 130 and 134 are well known in the industry and any one of a number of different types or kinds may be utilized within the contemplation of this invention, with no one in particular being required to practice the invention. Two exemplary jack assemblies are those disclosed in U.S. Pat. Nos. 4,975,087 and 5,938,478, as incorporated by reference elsewhere herein. DSX-3 assemblies are also well known and an exemplary assembly is disclosed in U.S. Pat. No. 5,233,501, which is hereby incorporated herein by this reference.

The jack assemblies 130 and 134 may but need not includes LED indicators 141 and 140, as are well known in the industry. The jack assemblies include switch assemblies and are preferably of the front access type, with terminal pin connector fields 132 being at the first end of the jack assemblies. The jack assemblies or circuits may also be what is generally referred to as “rear access” meaning the circuits are generally accessed from the rear end of the cabinet.

One jack assembly generally includes one circuit, which is well known in the art, and when reference is made herein to fifty-six or forty-two jack assemblies, this may also mean circuits and should include circuits if the jack assemblies are somehow combined. The cross-connect field may be wire-wrap pins, insulation displacement connectors (“IDC”), RJ-48 jacks, or others.

The jack assemblies 132 and 140 may be connected to the rear or backplane printed circuit board assembly 123 by any one of a number of different types of electrical conductors, such as ribbon cable, backplane interconnect boards 125 and 131, or in other ways.

The backplane printed circuit board assembly may be one continuous board, two independent boards, one for each set of jack assemblies and multiplexers, or even physically independent and individual boards, with many being known in the art. In this case the preferred way is one printed circuit board 123 with the typical rear connectors utilized with DSX-1 jack assemblies, such as terminal pin connectors, DS3 connectors, and the like.

The DSX-1 jack assemblies would typically include, for example a monitor sleeve 145, an input sleeve 143 and an output sleeve 144, all as are known in the art.

The multiplexers, namely first set 121 and second set 126 of multiplexer, are well known and used in the industry and not specific type or kind are required to practice this invention, but instead any one of a number of types, configurations and designs may be utilized. Furthermore the multiplexers 121 and 126 in the figure are mounted on the same horizontal plane as the DSX-1 jack assemblies 130 and 154, although they need not necessarily be.

In the preferred embodiment, the multiplexers 121 and 126 are M13's on printed circuit boards 122, which are mechanically and electrically connected to the rear or backplane printed circuit board assembly 123 with known connector technology (with no particular type being required to practice this invention), such as edge connectors 124 mounted on the backplane printed circuit board assembly 123.

In the preferred embodiment, there are active M13's and standby M13's. Since one M13 would handle the signals from all 28 circuits from a set of DSX-1 jack assemblies, only two multiplexers would actually be needed for operation on all fifty-six circuits. Rear or backplane printed circuit boards are generally known and the backplane printed circuit board assembly 123 will therefore not be described in further detail.

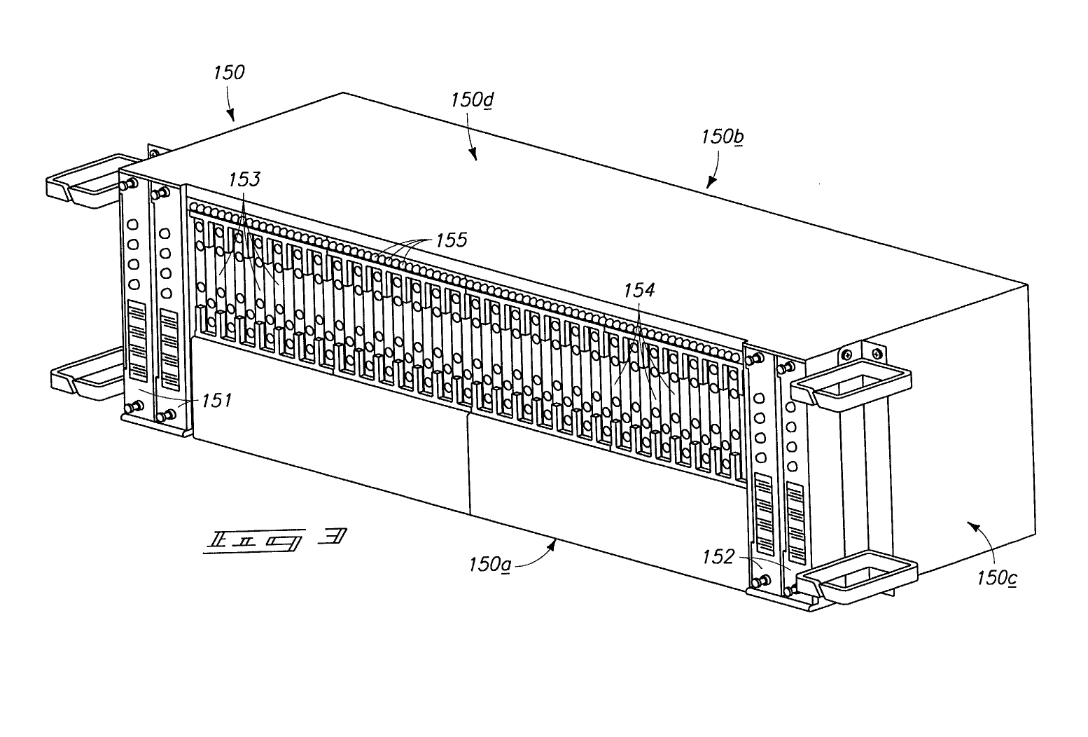

FIG. 3 is a perspective view of an embodiment of this invention which includes fifty-six DSX-1 jack assemblies and four multiplexers, with two multiplexers being on each side of the first end of the cabinet framework, each pair representing an active multiplexer and a standby multiplexer, preferably for the DSX-1 jack assemblies located on that side of the cabinet framework.

FIG. 3 illustrates an embodiment of a cabinet system which includes cabinet framework 150 with a first end 150a, a second end 150b, a top cover 150d, and side walls 150. This illustrates one of a number of different possible alternative configurations for this invention, with others also being contemplated by this invention. FIG. 3 also illustrates a first set of DSX-1 jack assemblies 153 and a second set of DSX-1 jack assemblies 154, and LED indicators 155 for the jack assemblies. A first set 151 of multiplexors being on one side of the cabinet framework 150 and a second set 152 of multiplexors being on the other side, each set representing an active and a standby multiplexor.

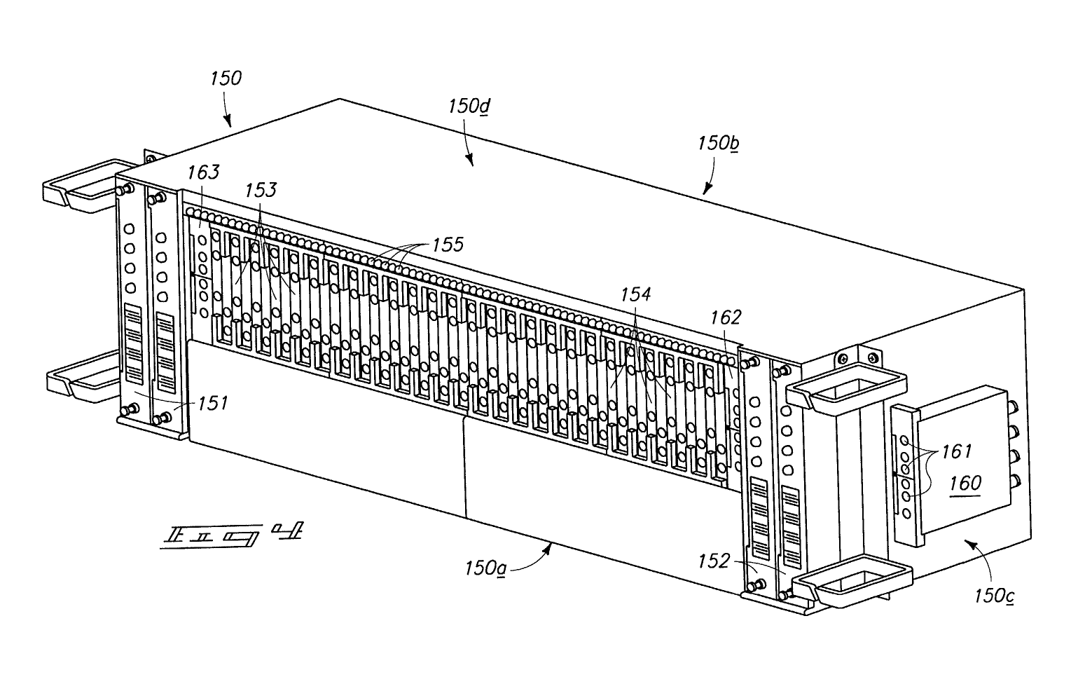

FIG. 4 is a perspective view of one embodiment of a cabinet system contemplated by this invention, wherein DSX-3 assemblies are included within the integrated cabinet system. The DSX-3 assemblies may be included in place of or with DSX-1 assemblies, in combination with the M13's, within the contemplation of this invention. The item numbers are the same as for FIG. 3, with the addition of the numbers identifying the DSX-3 assemblies. Other components are the same as those in FIG. 3 and are therefore provided with the same numbers.

In this integrated cabinet, DSX-3 assemblies 162 & 163 are mounted within the cabinet and integrated with the DSX-1 jack assemblies and the M13's. Also shown in this alternative embodiment is an exterior DSX-3 160 mounted on the side wall of the cabinet and electrically connected to the backplane printed circuit board assembly (not shown in this Figure). DSX-3 assemblies generally include jacks 161 in a front or rear panel.

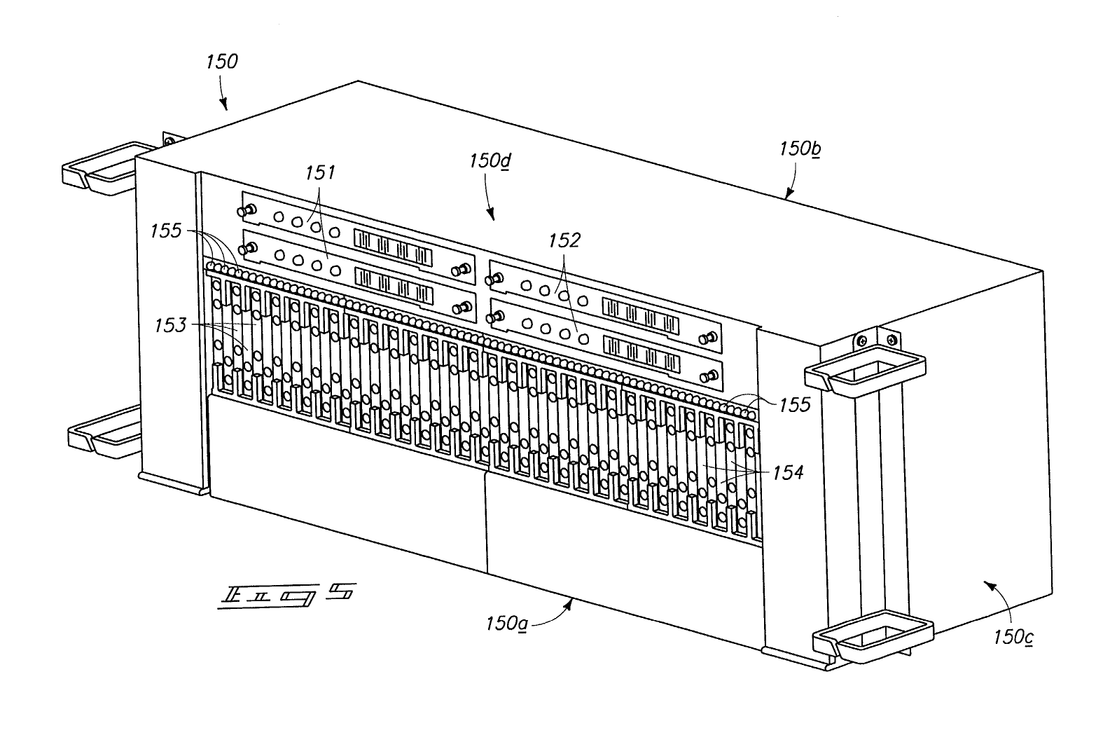

FIG. 5 is a perspective view of an embodiment of this invention which includes DSX-1 jack assemblies and four multiplexers, the multiplexers being configured within the cabinet but above the DSX-1 assemblies. The like components from FIG. 3 bear the same item numbers as the components in FIG. 3. FIG. 5 shows an alternative integrated configuration contemplated by this invention wherein the multiplexers 151 and 152 are mounted in a horizontal orientation above the DSX-1 assemblies.

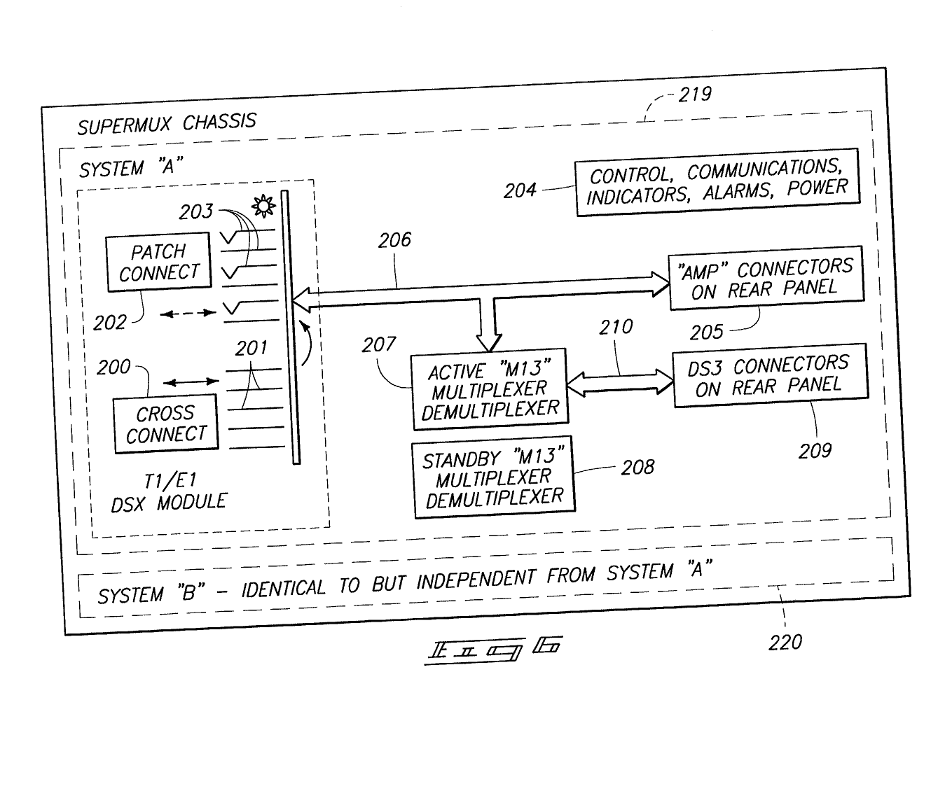

FIG. 6 is a functional block diagram of the cabinet system components of one embodiment of a cabinet system contemplated by this invention, illustrating the patch/connect jack assemblies in block 202, switch assemblies 203 for the jack assemblies 202, and terminal pin connectors 201 for cross-connecting the jack assemblies. The cross-connect field may be wire-wrap pins or RJ-48 jacks, or others.

FIG. 6 further illustrates active M13 in box 207, standby M13 in box 208, DS3 connectors on rear panel in block 209 electrically and operatively connected to the active M13 via connection 210. The “D” style or type connectors on the rear panel are electrically or operatively connected to the DSX-1 jack assemblies via connection 206. FIG. 6 further illustrates the control, communications, indicates, alarms and power items in box 204, which may be preferred, but are not required to practice this invention.

It should also be noted that the foregoing depictions in FIG. 6 are within block 219, which only represents two multiplexors and twenty-eight DSX-1 jack assemblies. In an embodiment of the invention which would include four multiplexors and fifty-six DSX-1 jack assemblies, a similar or identical block depiction would be shown in block 220. The active system would preferably be independent from the standby system, perhaps only sharing a ground stud. There would preferably be no shared connections. The cross-connect field may be wire-wrap pins or RJ-48 jacks.

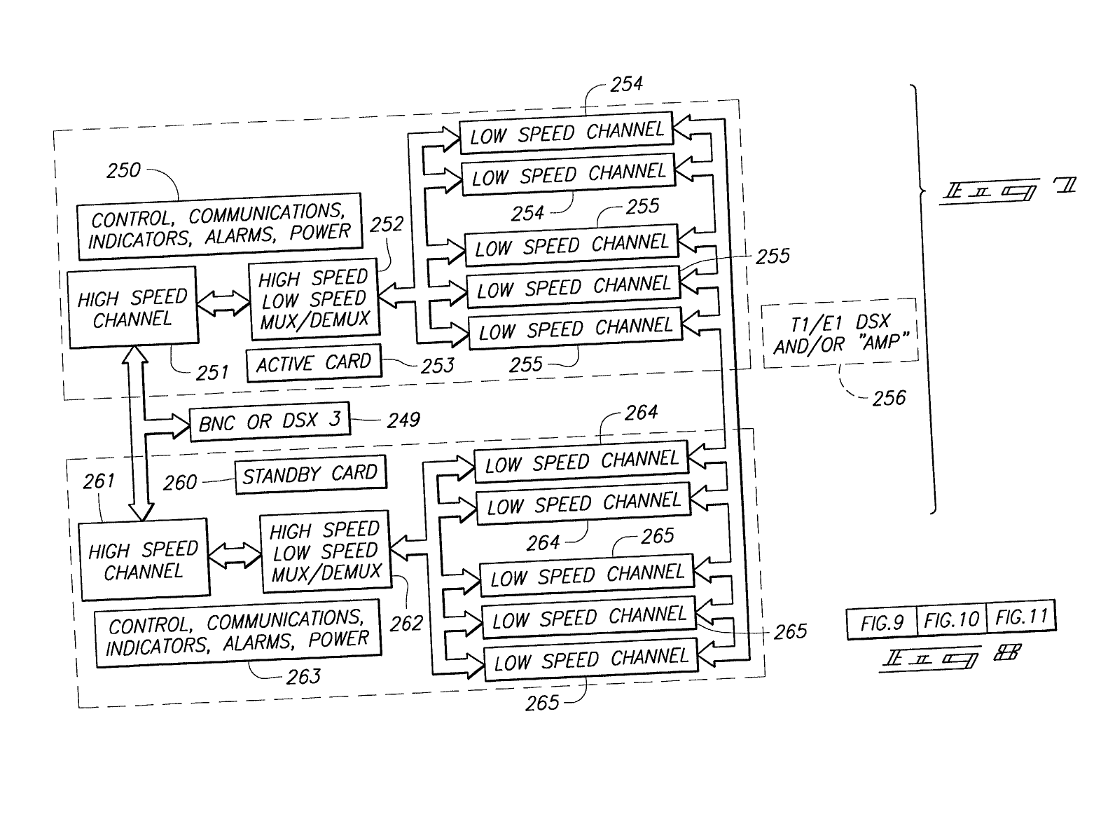

FIG. 7 is a system block diagram of the cabinet system components of one embodiment of a cabinet system contemplated by this invention. FIG. 7 shows the mirror systems, the first with an active multiplexer card 253 and the second mirror system with a standby multiplexer card 262. While the systems need not be identical, it is preferred that they be identical.

FIG. 7 illustrates control, communications, indicates, alarms and power in boxes 250 and 263. These would include such aspects of the product as: initialization, configuration, provisioning, performance, monitoring, protection switching, and active/standby board control; ethernet and RS232 communications channels supporting SNMP, TL1 and craft interface protocols; alarm relays, status indicator, and ACO test push button; and power supplies.

The high speed channel blocks 251 and 261 (may also be referred to as high bandwidth) may preferably represent DS3 line interface units devices for copper or a fiber optic converter for optical applications, both of which are known in the art. The high speed/low speed multiplexer/demultiplexer blocks 252 and 262 multiplex the low speed channels into the high speed channel and the high speed channel into the low speed channel.

The low speed channel blocks, 254, 255, 264 and 265 may preferably be up to twenty-eight T1 lines or 21 E1 lines, or some combination of the two. Block 256 represents T1, E1, DSX and/or “D” style or type super ribbons connectors on the backplane printed circuit board assembly.

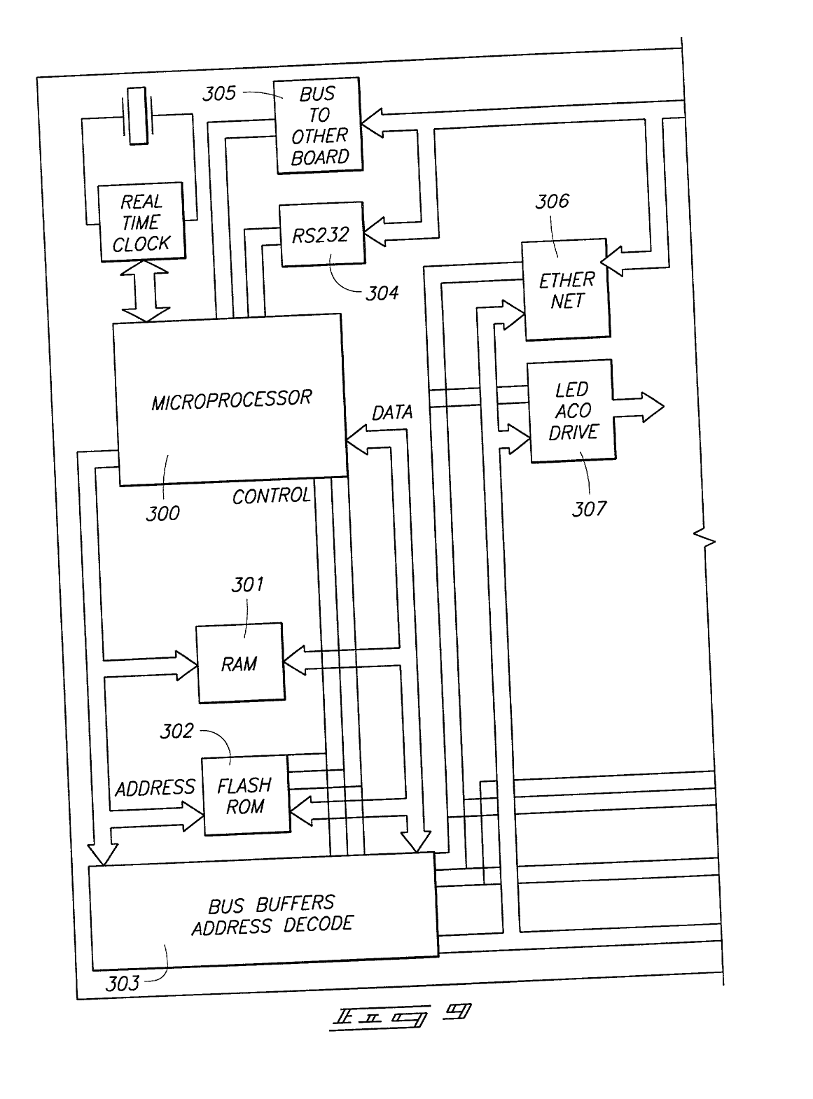

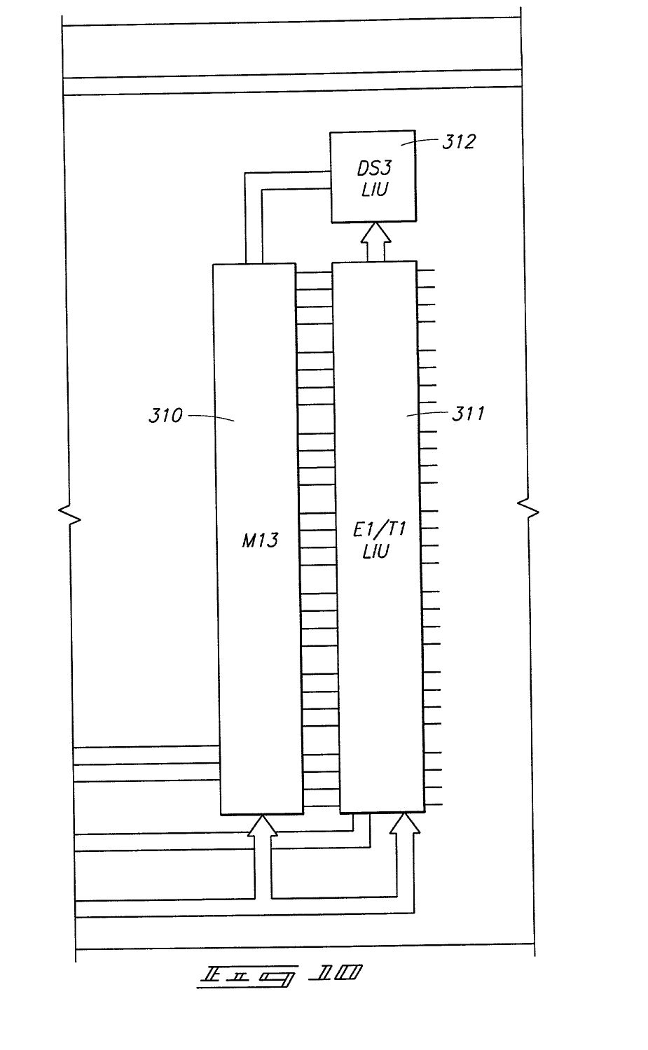

FIG. 8 is a diagram of the relationship of FIGS. 9-11, which comprise an electrical block diagrams of one embodiment of a cabinet system contemplated by the invention.

FIG. 9 is an electrical block diagram of the cabinet system components of one embodiment of a cabinet system contemplated by this invention, as depicted in FIG. 8. FIG. 9 illustrates well known components utilized in printed circuit board assemblies, showing microprocessor 300 which may be any one of a number of different multi-processors, such as those made by Motorola, RS232 connection 304, Random Access Memory (RAM) 302, bus buffers address decoders 303, buffered address and data 309, ethernet connection 306, flash Read Only Memory (“ROM”) 302 and LED ACO interface 307. It will be noted by those of ordinary skill in the art that there are numerous way a printed circuit board assembly may be conducted, assembled and/or arranged, within the contemplation of this invention, with no one in particular being required to practice this invention.

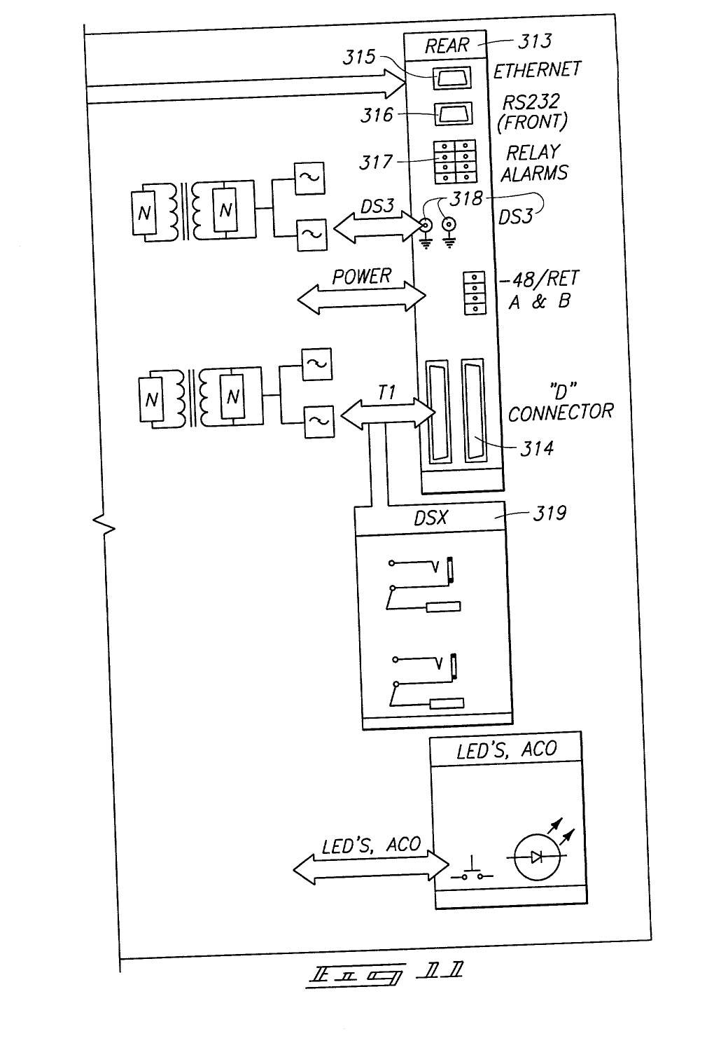

FIG. 10 is an electrical block diagram of the cabinet system components of one embodiment of a cabinet system contemplated by this invention, as depicted in FIG. 8. FIG. 10 illustrates M13 310, T1 or E1 line interface units 311, and DS3 line interface unit 312.

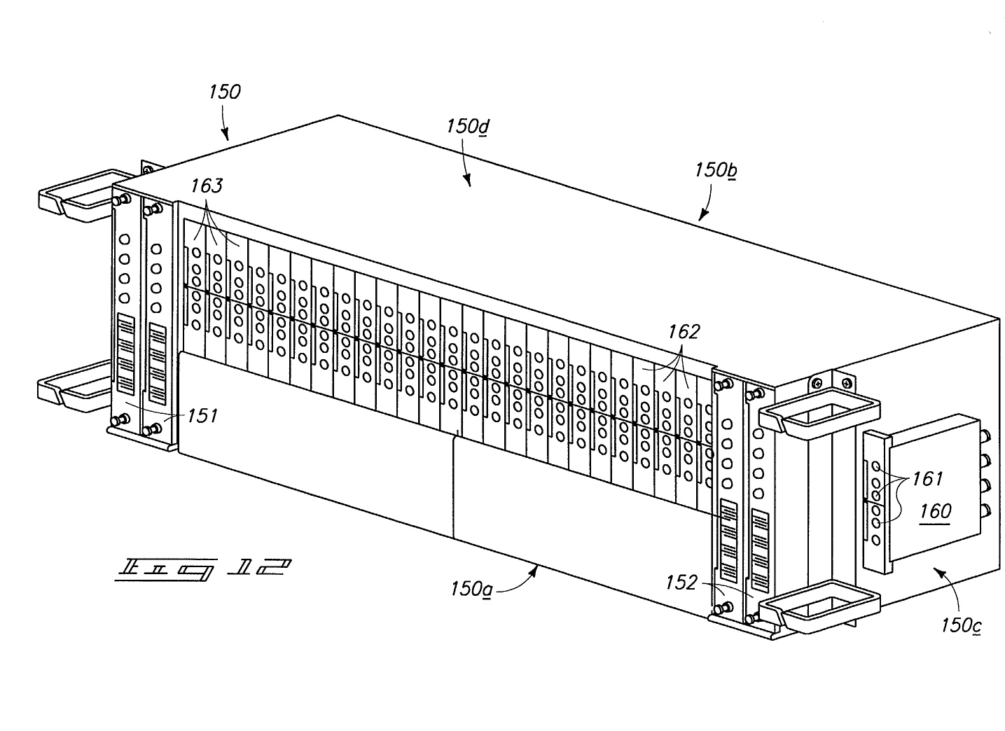

FIG. 11 is an electrical block diagram of the cabinet system components of one embodiment of a cabinet system contemplated by this invention, as depicted in FIG. 8. FIG. 11 illustrates some of the connections and other components, such as ethernet connection 315, RS232 (front) connection 316, relay alarms 317, DS3 connection 318, DSX-1 connection 319, “D” style or type connector 314.

FIG. 12 is a perspective view of an embodiment of this invention which includes DSX-3 assemblies and four multiplexers, with two multiplexers being on each outward side of the first end of the cabinet framework. FIG. 12 is similar to FIG. 4 with like items being numbered the same as in FIG. 4, and illustrates an embodiment of the invention wherein there are only DSX-3 assemblies combined with the M13's. Typically there are two DSX-3 assemblies for each M13 and the DSX-3 assemblies may be placed in a smaller area. For instance, the height of the cabinet framework 150 could be in the two to six inch range, with four inches being a typical height for the DSX-3 cabinet framework.

As will be appreciated by those of reasonable skill in the art, there are numerous embodiments to this invention, and variations of elements and components which may be used, all within the scope of this invention.

One embodiment of this invention for example involves a telecommunications cabinet assembly comprised of: a cabinet framework with a first end and a second end; a plurality of DSX-1 jack assemblies mounted on the cabinet framework, each jack assembly being comprised of: a front panel portion which includes a single column of at least one sleeve for receiving a plug therein; a switch assembly support portion; and at least one switch assembly positioned within the framework rearward from the corresponding sleeve, the switch assembly being adapted to receive and make electrical contact with a plug inserted in the corresponding sleeve; and at least one multiplexer mounted on the cabinet framework and disposed to be accessed from the first end of the cabinet framework. In addition to the foregoing, this invention contemplates the following: a telecommunications cabinet assembly as recited above and further wherein the plurality of DSX-1 jack assemblies are each removably secured to the first end of the cabinet framework; a telecommunications cabinet assembly as stated above and further wherein the plurality of DSX-1 jack assemblies include at least forty-two DSX-1 circuits; a telecommunications cabinet assembly as stated above and further wherein the at least one multiplexer comprises an M13 multiplexer/demultiplexer; a telecommunications cabinet assembly as stated above and further comprising a backplane circuit board assembly electrically connected to the at least one multiplexer and the plurality of DSX-1 jack assemblies. Still further embodiments of this invention would include the telecommunications cabinet assembly as recited in the preceding paragraph and further including: at least one DSX-3 jack assembly mounted on the cabinet framework; or wherein the at least one multiplexer is mounted in the same horizontal plane as the plurality of DSX-1 jack assemblies; or wherein the at least one multiplexer is comprised of one active and one standby multiplexer. The telecommunications cabinet assembly recited above may also be provided wherein the plurality of multiplexers comprise: a high speed transmission line interface unit responsible for signal input-output interface with a set of sending and receiving high speed transmission lines; a low speed transmission line interface unit responsible for signal input-output interface with a set of sending and receiving low speed transmission lines; and a multiplex converting unit for performing multiplexing and demultiplexing between high speed signals transmitted on the high speed transmission lines and low speed signals transmitted on the low speed transmission lines. In such a case the telecommunications cabinet assembly may be provided wherein the interface between the multiplex converting unit and the switch assemblies comprises an optical fiber interface.

As shown, embodiments of the telecommunications cabinet assembly further may include a backplane printed circuit board assembly mounted to the cabinet framework; and an interconnect printed circuit board electrically coupling the jack assemblies with the backplane printed circuit board assembly; or wherein the plurality of jack assemblies are disposed to be accessed from the front end of the cabinet framework.

Another embodiment of the invention may be a telecommunications cabinet assembly comprised of: a cabinet framework with a first end and a second end, and wherein the framework defines a width dimension to a height dimension ratio which is greater than one; a plurality of DSX-1 jack assemblies mounted on the cabinet framework; and at least one multiplexer mounted on the cabinet framework. In such a case the cabinet framework may define the width dimension to height dimension ratio at greater than three and less than four, or in a range from 14 inches to 24 inches. The telecommunications cabinet assembly described above may also define the height dimension to be in a range from 3 inches to 6 inches.

In another embodiment of the invention, a telecommunications cabinet assembly may be provided which is comprised of: a cabinet framework with a first end and a second end, the cabinet framework configured to mount to a nineteen inch wide distribution rack; at least forty-two DSX-1 jack assemblies mounted on the cabinet framework; and at least two multiplexers mounted on the cabinet framework, the at least two multiplexers being electrically connected to the at least forty-two DSX-1 jack assemblies. In such a telecommunications cabinet assembly, there may also be a backplane circuit board assembly electrically connected to the at least one multiplexer and the at least forty-two DSX-1 circuits.

Yet another embodiment of a telecommunications cabinet assembly contemplated by this invention may be comprised of: a cabinet framework with a first end and a second end; a plurality of DSX-1 jack assemblies mounted on the cabinet framework, each jack assembly being comprised of: a front panel portion which includes

a single column of at least one sleeve for receiving a plug therein;

a switch assembly support portion; and

at least one switch assembly positioned within the framework rearward from the corresponding sleeve, the switch assembly being adapted to receive and make electrical contact with a plug inserted in the corresponding sleeve;

at least one multiplexer mounted on the cabinet framework; and a backplane circuit board electrically connected to the at least one multiplexer and the plurality of DSX-1 jack assemblies. In such an embodiment, the telecommunications cabinet assembly may further involve the backplane circuit board assembly being electrically connected to the at least one multiplexer and the plurality of DSX-1 jack assemblies by a backplane interconnect conductor.

Another telecommunications cabinet assembly contemplated by this invention may be comprised of a cabinet framework with a first end and a second end, the cabinet framework having a vertical height of less than twelve inches, the cabinet framework including a first set of DSX-1 jack assemblies mounted on and disposed to be accessed from the first end of the cabinet framework, a first multiplexer mounted on and disposed to be accessed from the first end of the cabinet framework, the first multiplexer being electrically connected to the first set of DSX-1 jack assemblies; and wherein there is at least one multiplexer and at least twenty-eight DSX-1 jack assemblies mounted in the cabinet framework. This embodiment may further include the first multiplexer being electrically connected to the first set of DSX-1 jack assemblies through a backplane printed circuit board assembly, or wherein there are at least two multiplexers and at least fifty-six DSX-1 circuits mounted on the cabinet framework. In such a case, the vertical height may, but need not be, less than six inches. There may also be at least two multiplexers and at least fifty-six DSX-1 circuits mounted on the cabinet framework.

Another embodiment of a telecommunications cabinet assembly contemplated by this invention may be comprised of a cabinet framework with a first end and a second end, the cabinet framework having a vertical height of less than twelve inches, the cabinet framework including a first set of DSX-1 jack assemblies mounted on the cabinet framework, a first multiplexer mounted on the cabinet framework, the first multiplexer being electrically connected to the first set of DSX-1 jack assemblies; and wherein the first multiplexer is mounted on a same horizontal plane within the cabinet as the first set of DSX-1 jack assemblies.

In yet another embodiment, a telecommunications cabinet assembly may be comprised of: a cabinet framework with a first end and a second end; a plurality of DSX-3 assemblies mounted on the cabinet framework; and at least one multiplexer mounted on the cabinet framework and electrically connected to the plurality of DSX-3 assemblies. In this embodiment, DSX-1 assemblies would not be included.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A telecommunications cabinet assembly comprised of:
(a) a cabinet framework with a first end and a second end;
(b) a plurality of DSX-1 jack assemblies mounted on the cabinet framework; and
(c) at least one multiplexer mounted on the cabinet framework and disposed to be accessed from the first end of the cabinet framework.

2. A telecommunications cabinet assembly as recited in claim 1, and further wherein each jack assembly is comprised of:
(a) a front panel portion which includes a single column of at least one sleeve for receiving a plug therein;
(b) a switch assembly support portion; and
(c) at least one switch assembly positioned within the framework rearward from the corresponding sleeve, the switch assembly being adapted to receive and make electrical contact with a plug inserted in the corresponding sleeve.

3. A telecommunications cabinet assembly as recited in claim 1, and further wherein the plurality of DSX-1 jack assemblies are each removably secured to the first end of the cabinet framework.

4. A telecommunications cabinet assembly as recited in claim 1, and further wherein the plurality of DSX-1 jack assemblies comprise at least forty-two DSX-1 circuits.

5. A telecommunications cabinet assembly as recited in claim 1, and further wherein the at least one multiplexer comprises an M13 multiplexer/demultiplexer.

6. A telecommunications cabinet assembly as recited in claim 1, and further comprising a backplane circuit board assembly electrically connected to the at least one multiplexer and the plurality of DSX-1 jack assemblies.

7. A telecommunications cabinet assembly as recited in claim 1, and further comprising at least one DSX-3 jack assembly mounted on the cabinet framework.

8. A telecommunications cabinet assembly as recited in claim 1, and further wherein the at least one multiplexer is mounted in the same horizontal plane as the plurality of DSX-1 jack assemblies.

9. A telecommunications cabinet assembly as recited in claim 1, and further wherein the at least one multiplexer is comprised of one active and one standby multiplexer.

10. A telecommunications cabinet assembly as recited in claim 1, and further wherein the plurality of multiplexers comprise:
(a) a high speed transmission line interface unit responsible for signal input-output interface with a set of sending and receiving high speed transmission lines;
(b) a low speed transmission line interface unit responsible for signal input-output interface with a set of sending and receiving low speed transmission lines; and
(c) a multiplex converting unit for performing multiplexing and demultiplexing between high speed signals transmitted on the high speed transmission lines and low speed signals transmitted on the low speed transmission lines.

11. A telecommunications cabinet assembly as recited in claim 10, and further wherein the interface between the multiplex converting unit and the switch assemblies comprises an optical fiber interface.

12. A telecommunications cabinet assembly as recited in claim 1, and further comprising:
(a) a backplane printed circuit board assembly mounted to the cabinet framework; and
(b) an interconnect printed circuit board electrically coupling the jack assemblies with the backplane printed circuit board assembly.

13. A telecommunications cabinet assembly as recited in claim 1, and wherein the plurality of jack assemblies are disposed to be accessed from the front end of the cabinet framework.

14. A telecommunications cabinet assembly comprised of:
(a) a cabinet framework with a first end and a second end, and wherein the framework defines a width dimension to a height dimension ratio which is greater than one;
(b) a plurality of DSX-1 jack assemblies mounted on the cabinet framework; and
(c) at least one multiplexer mounted on the cabinet framework.

15. A telecommunications cabinet assembly as recited in claim 14, and further wherein the framework defines the width dimension to height dimension ratio at greater than three and less than four.

16. A telecommunications cabinet assembly as recited in claim 14, and further wherein the framework defines the width dimension to be in a range from 14 inches to 24 inches.

17. A telecommunications cabinet assembly as recited in claim 14, and further wherein the framework defines the height dimension to be in a range from 3 inches to 6 inches.

18. A telecommunications cabinet assembly comprised of:
(a) a cabinet framework with a first end and a second end, the cabinet framework configured to mount to a nineteen inch wide distribution rack;
(b) at least forty-two DSX-1 jack assemblies mounted on the cabinet framework; and
(c) at least two multiplexers mounted on the cabinet framework, the at least two multiplexers being electrically connected to the at least forty-two DSX-1 jack assemblies.

19. A telecommunications cabinet assembly as recited in claim 18, and further comprised of a backplane circuit board assembly electrically connected to the at least one multiplexer and the at least forty-two DSX-1 circuits.

20. A telecommunications cabinet assembly comprised of:
(a) a cabinet framework with a first end and a second end;
(b) a plurality of DSX-1 jack assemblies mounted on the cabinet framework, each jack assembly being comprised of:
(i) a front panel portion which includes a single column of at least one sleeve for receiving a plug therein;
(ii) a switch assembly support portion; and
(iii) at least one switch assembly positioned within the framework rearward from the corresponding sleeve, the switch assembly being adapted to receive and make electrical contact with a plug inserted in the corresponding sleeve;
(c) at least one multiplexer mounted on the cabinet framework;
(d) a backplane circuit board electrically connected to the at least one multiplexer and the plurality of DSX-1 jack assemblies.

21. A telecommunications cabinet assembly as recited in claim 20, and further wherein the backplane circuit board assembly is electrically connected to the at least one multiplexer and the plurality of DSX-1 jack assemblies by a backplane interconnect conductor.

22. A telecommunications cabinet assembly comprised of a cabinet framework with a first end and a second end, the cabinet framework having a vertical height of less than twelve inches, the cabinet framework including a first set of DSX-1 jack assemblies mounted on and disposed to be accessed from the first end of the cabinet framework, a first multiplexer mounted on and disposed to be accessed from the first end of the cabinet framework, the first multiplexer being electrically connected to the first set of DSX-1 jack assemblies;
and wherein there is at least one multiplexer and at least twenty-eight DSX-1 jack assemblies mounted on the cabinet framework.

23. A telecommunications cabinet assembly as recited in claim 22, and further wherein the first multiplexer electrically connected to the first set of DSX-1 jack assemblies through a backplane printed circuit board assembly.

24. A telecommunications cabinet assembly as recited in claim 22, only wherein there are at least two multiplexers and at least fifty-six DSX-1 circuits mounted on the cabinet framework.

25. A telecommunications cabinet assembly as recited in claim 22, only wherein the cabinet framework has a vertical height of less than six inches.

26. A telecommunications cabinet assembly as recited in claim 22, only wherein there are at least two multiplexers and at least fifty-six DSX-1 circuits mounted on the cabinet framework.

27. A telecommunications cabinet assembly comprised of a cabinet framework with a first end and a second end, the cabinet framework having a vertical height of less than twelve inches, the cabinet framework including a first set of DSX-1 jack assemblies mounted on the cabinet framework,
a first multiplexer mounted on the cabinet framework, the first multiplexer being electrically connected to the first set of DSX-1 jack assemblies; and
wherein the first multiplexer is mounted on a same horizontal plane within the cabinet as the first set of DSX-1 jack assemblies.

28. A telecommunications cabinet assembly comprised of:
(a) a cabinet framework with a first end and a second end;
(b) a plurality of DSX-3 assemblies mounted on the cabinet framework; and
(c) at least one multiplexer mounted on the cabinet framework and electrically connected to the plurality of DSX-3 assemblies.
